(19) United States
(12) Patent Application Publication
(10) Pub. No.: US 2021/0264410 A1
(43) Pub. Date: Aug. 26, 2021

(54) ONLINE WALLET DEVICE AND METHOD FOR CREATING AND VERIFYING SAME

(71) Applicant: SEOUL NATIONAL UNIVERSITY R&DB FOUNDATION, Gwanak-gu, Seoul (KR)

(72) Inventors: Yun Heung PAEK, Gwanak-gu, Seoul (KR); Hyun Young OH, Gwanak-gu, Seoul (KR)

(21) Appl. No.: 17/259,350

(22) PCT Filed: Sep. 13, 2018
(86) PCT No.: PCT/KR2018/010731

§ 371 Date: Mar. 12, 2021

(30) Foreign Application Priority Data
Jul. 9, 2018 (KR) 10-2018-0079573

(51) Int. Cl. G06Q 20/36; G06Q 20/06; G06Q 20/38; H04L 9/08

(52) U.S. Cl. CPC G06Q 20/3674; G06Q 20/065; H04L 2209/56; H04L 9/0894; H04L 9/0825; G06Q 20/3829

(57) ABSTRACT

Disclosed are an online wallet device and a method of generating and verifying the same. The online wallet device includes a first memory in which a key is stored, a second memory for storing an agent-bitstream including at least one agent that accesses the key stored in the first memory or performs a key-related operation, and an FPGA chip on which at least one agent is installed through loading of the agent-bitstream.

### TECHNICAL FIELD

The present disclosure relates to an online wallet, and more particularly, to an online wallet device capable of safely storing and using a key for a cryptocurrency, etc. and a method for generating and verifying the online wallet.

### BACKGROUND ART

A private key to be used during transaction of cryptocurrencies such as bitcoin and ethereum is required to execute a user operation regarding a cryptocurrency. The private key is the same as credential indicating an owner of the cryptocurrency, and loss or theft of the private key may be interpreted as loss or theft of the cryptocurrency. Therefore, security for a cryptocurrency wallet that stores various keys of users including private keys is important. However, since the private key is used for all transactions using the cryptocurrency, the private key is inevitably exposed to various security threats.

Recently, various brands of hardware wallets with enhanced security have appeared, and representative examples thereof are Ledger, Trezor, and the like. Such a hardware wallet may store a private key in a universal serial bus (USB) device and may completely separate the hardware wallet from online activity when the private key is not used. That is, the hardware wallet may be a kind of cold wallet that stores the private key in a cold storage that is not connected to an online environment and allows limited access to the private key only when a transaction occurs. However, existing hardware wallets require users to purchase a personal wallet which is expensive, have the hassle of having to be carried individually, and are vulnerable to loss or damage.

On the other hand, a hot wallet, which is a cryptocurrency wallet implemented and operated in the form of software, does not require the user to directly have the hot wallet and also has the convenience of allowing access to and transaction of a cryptocurrency anywhere. However, a server of a hot wallet, which provides a software environment for the operation of the user's wallet, may be easily targeted by hackers due to vulnerability of software of the server or software of the hot wallet, and if private keys of users are leaked due to such an attack, a large amount of financial damage may occur. As a real example, in January 2018, Coin Check, the largest cryptocurrency exchange in Japan, lost 560 billion won worth of cryptocurrency due to hackers' attack. Attack attempts by hackers seeking great monetary gains are increasing, and thus, in online exchanges that transact cryptocurrency, safely storing and managing user's keys has become an urgent and important issue.

### DESCRIPTION OF EMBODIMENTS

### Technical Problem

A technical problem to be achieved by the present disclosure is to provide an online wallet device that may safely store and allow use a key for a cryptocurrency, etc.

Another technical problem to be achieved by the present disclosure is to provide a method of generating an online wallet that may safely store and allow use of a key for a cryptocurrency, etc. and a method of verifying the online wallet.

### Solution to Problem

An example of an online wallet device according to an embodiment of the present disclosure for achieving the above technical problem may include: a first memory in which a key is stored; a second memory for storing an agent-bitstream comprising at least one agent that performs accessing to the key stored in the first memory or performs a key-related operation; and an FPGA chip on which at least one agent is installed through loading of the agent-bitstream.

An example of a method of generating an online wallet according to an embodiment of the present disclosure for achieving the above technical problem may include: storing a key in a first memory; storing an agent-bitstream in a second memory, in which the agent-bitstream comprises at least one agent that performs accessing to the key stored in the first memory or performs a key-related operation; and

packaging an FPGA chip by connecting to the first memory and the second memory.

An example of a method of generating an online wallet according to an embodiment of the present disclosure for achieving the above technical problem may include: loading an agent-bitstream on an FPGA chip, in which the agent-bitstream comprises at least one agent that performs accessing to a key stored in a memory or performs a key-related operation; and installing a wallet of an user by decrypting a wallet-agent comprising a transaction key of cryptocurrency with the key and loading the decrypted wallet-agent on the FPGA chip.

An example of a method of generating an online wallet according to an embodiment of the present disclosure for achieving the above technical problem may include: loading a wallet-bitstream received from an user terminal on an FPGA chip of an online wallet device; generating a first signature by signing a nonce value received from the user terminal with a key stored in a memory of the online wallet device; generating a second signature by signing the nonce value with a verification-private key that is comprised in the wallet-bitstream; and transmitting the first signature and the second signature to the user terminal.

### Advantageous Effects of Disclosure

According to an embodiment of the present disclosure, an user wallet may be stored and managed in the form of a field programmable gate array (FPGA) bitstream, and may be implemented as a kind of hot wallet that operates on an internal hardware of the FPGA, so that keys used for a cryptocurrency may be safely stored and used. Unlike a conventional hardware wallet, the wallet of the present disclosure may provide convenience for users to transact the cryptocurrency online without carrying the wallet and mobility to easily move transaction servers. In addition, since the wallet of present disclosure may remotely verify forgery and alteration of an online wallet, the wallet of present disclosure may provide higher security compared to existing hot wallets.

The online wallet according to an embodiment of the present disclosure may have versatility in that the online wallet may be implemented in various types of systems such as an Intel-based desktop computer or a server computer. In addition, the online wallet of the present disclosure may be implemented in the form of a System on Chip (SoC) in an ARM system, so that the online wallet may be applied to an Internet of Things (IoT) system.

In addition, the online wallet of the present disclosure may customize the bitstream that is loaded on the online wallet. For example, a wallet manufacturer may generate the bitstream by adding a module for cryptocurrency transaction requested by the user. In addition, unlike the hardware wallet of a conventional cold wallet, which is difficult to modify and regenerate functions once the wallet is generated, the online wallet of the present embodiment may be easily regenerated. When the user wants to exchange the cryptocurrency wallet for a new wallet due to the loss of the wallet, the transaction of a new coin, or the use of another transaction server, etc. the user may request the wallet manufacturer to provide an online wallet that fits their needs.

### BRIEF DESCRIPTION OF DRAWINGS

FIG. 1 is a diagram illustrating an example of a schematic system structure to which an online wallet according to an embodiment of the present disclosure is applied;

FIG. 2 is a diagram illustrating an example of a configuration of an online wallet device according to an embodiment of the present disclosure;

FIG. 3 is a diagram illustrating a relationship between subjects using an online wallet according to an embodiment of the present disclosure;

FIG. 4 is a diagram illustrating an example of loading a bitstream on an online wallet device according to an embodiment of the present disclosure;

FIG. 5 is a diagram illustrating an example of a configuration of a primitive-agent according to an embodiment of the present disclosure;

FIG. 6 is a diagram illustrating an example of a configuration of a wallet-agent according to an embodiment of the present disclosure;

FIG. 7 is a diagram illustrating an example of a configuration of a wallet-bitstream according to an embodiment of the present disclosure;

FIG. 8 is a flowchart illustrating an example of a method of generating an online wallet according to an embodiment of the present disclosure;

FIG. 9 is a flowchart illustrating another example of a method of generating an online wallet according to an embodiment of the present disclosure;

FIG. 10 is a flowchart illustrating an example of a method of updating an online wallet according to an embodiment of the present disclosure;

FIG. 11 is a flowchart illustrating an example of a method of verifying an online wallet according to an embodiment of the present disclosure;

FIG. 12 is a flowchart illustrating an example of a method of transacting a cryptocurrency according to an embodiment of the present disclosure;

FIG. 13 is a flowchart illustrating an example of a method of moving an online wallet according to an embodiment of the present disclosure; and

FIG. 14 is a diagram illustrating an example of a method of increasing the efficiency of cryptocurrency transactions according to an embodiment of the present disclosure.

### MODE OF DISCLOSURE

Hereinafter, an online wallet device according to an embodiment of the present disclosure and a method of generating and verifying the same will be described in detail with reference to the accompanying drawings.

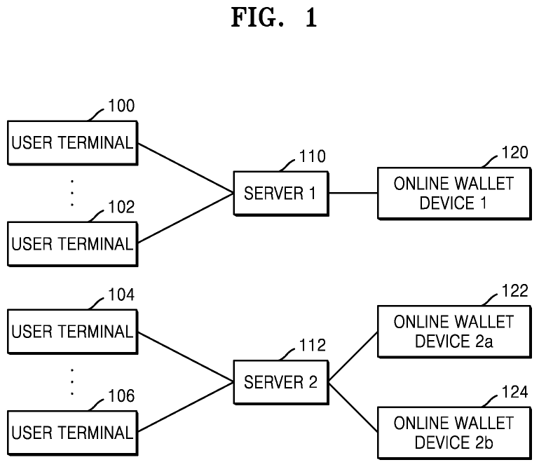

FIG. 1 is a diagram illustrating an example of a schematic system structure to which an online wallet according to an embodiment of the present disclosure is applied.

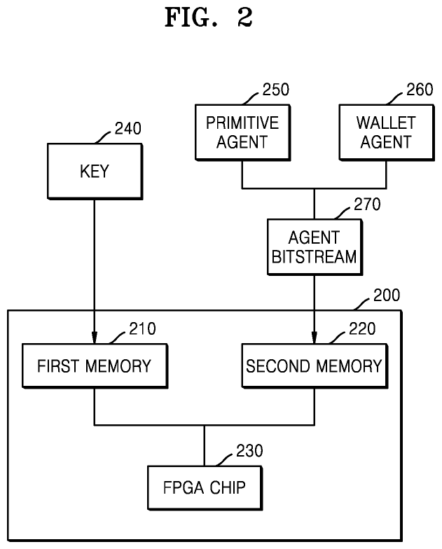

Referring to FIG. 1, online wallet devices 120, 122, and 124 are connected to servers 110 and 112. The online wallet devices 120, 122, and 124 may be manufactured in the form of cards to be mounted in connection slots of the servers 110 and 112. For example, the online wallet devices 120, 122, and 124 may be mounted in peripheral component Interconnect express (PCIe) slots of the servers 110 and 112. The online wallet devices 120, 122, and 124 may be implemented as an FPGA, and FPGA programming may be performed through a bitstream stored in a memory in the online wallet devices 120, 122, and 124, which are hardware-wise separated from the servers 110 and 112. An example of the online wallet devices 120, 122 and 124 is shown in FIG. 2.

At least one online wallet devices 120, 122, and 124 may be mounted on the servers 110 and 112. For example, one online wallet device 120 may be mounted on a first server 110 and two online wallet devices 122 and 124 may be mounted on a second server 112. The servers 110 and 112 may provide various services using an online wallet. For example, the servers 110 and 112 may be applied to various fields such as deposit/withdrawal and cryptocurrency transactions using the online wallet, and are not limited to a specific field. However, in the following description, for convenience of explanation, the field to which the servers 110 and 112 are applied is explained with limiting to the field of cryptocurrency.

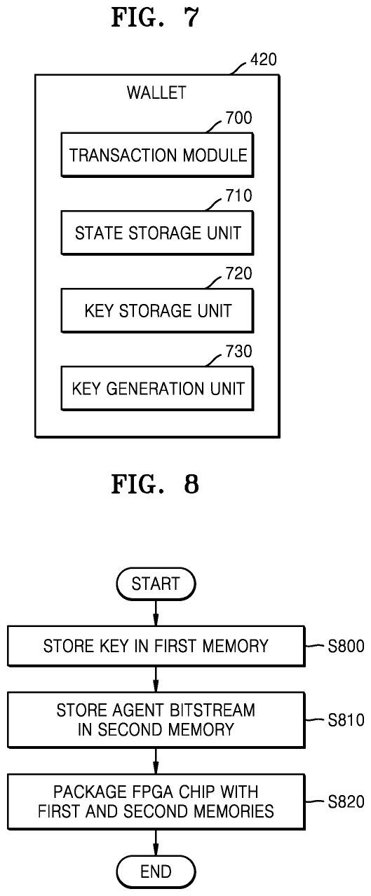

In cryptocurrency transactions, cryptocurrency wallets may be used that perform operations necessary for cryptocurrency transactions, such as generating and managing private and public keys for cryptocurrency transactions, as well as transaction operations or signature creation. In this embodiment, the cryptocurrency wallet may be implemented with the bitstream, which is configuration data to be loaded on an FPGA chip of the online wallet devices 120, 122, and 124. The bitstream that is loaded on the online wallet devices 120, 122, and 124 and serves as an online wallet for cryptocurrency transactions is hereinafter referred to as a wallet-bitstream. An example of the wallet-bitstream is shown in FIG. 7.

When a user connects to the server 110 and 112 of an FPGA card manager through user terminals 100, 102, 104, and 106, and then the wallet-bitstream assigned to each user terminals 100, 102, 104, and 106 is loaded on the online wallet device 120, 112, and 124, the cryptocurrency may be transacted. The wallet-bitstream is the bitstream equipped with the private key, etc. for cryptocurrency transactions. The online wallet devices 120, 122, and 124 may load the wallet-bitstream received from the FPGA card manager only when the cryptocurrency transaction is required, and destroy the wallet-bitstream when the transaction is completed.

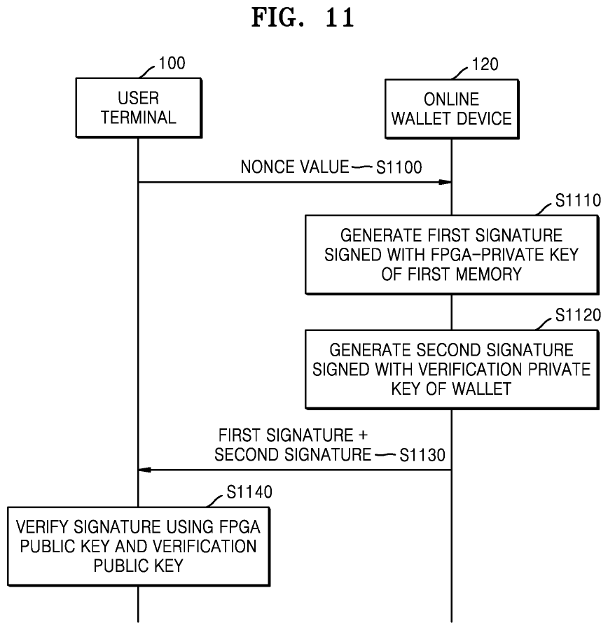

The user terminals 100, 102, 104, and 106 may remotely verify whether their wallet-bitstream is correctly loaded on the online wallet devices 120, 122, and 124 that are mounted in the servers 110 and 112. A remote attestation method will be described in FIG. 11. A method of safely managing private keys, and the like for transactions included in the wallet-bitstream, will be described below in FIG. 2.

This embodiment shows an example in which the online wallet devices 120, 122, and 124 are mounted on the servers 110 and 112, but as another example, the online wallet devices 120, 122, and 124 may be mounted on the user terminals 100, 102, 104, and 106. The user terminals 100, 102, 104 and 106 may include all kinds of terminals capable of wire or wireless communication, such as a smart phone, a general computer, and a tablet PC.

As another example, the wallet-bitstream may be stored in a storage device in a server of the FPGA card manager, not in the user terminals 100, 102, 104, and 106. Even though the wallet-bitstream is stored in a place other than the user terminal, the online wallet devices 120, 122, and 124 may load the wallet-bitstream of the user only when the cryptocurrency transaction of the user is required, and the same may be applied in a verification process of the online wallet to be examined later. Hereinafter, for convenience of explanation, it is assumed that the wallet-bitstream is stored in the user terminals 100, 102, 104, and 106.

FIG. 2 is a diagram illustrating an example of a configuration of an online wallet device according to an embodiment of the present disclosure.

Referring to FIG. 2, the online wallet device 200 may include a first memory 210, a second memory 220, and an FPGA chip 230. The first and second memories 210 and 220 may be implemented as various types of memories. As an example, the first and second memories 210 and 220 may be implemented as read only memory (ROM) to prevent forgery of stored data. The first memory 210 may be physically or logically separated from the second memory 220.

The FPGA chip 230 refers to a programmable integrated circuit. In the present embodiment, the FPGA chip 230 is referred to for better understanding, but the term is not limited thereto, and the FPGA chip 230 may be defined as that including all types of chips that may be programmed using the bitstream to be described later.

A key 240 may be stored in the first memory 210, and a bitstream 270 loaded on the FPGA chip may be stored in the second memory 220. There are two types of bitstreams used in this embodiment. There are a bitstream (hereinafter referred to as an agent-bitstream) to be stored in the second memory 220 and loaded onto the FPGA chip 230 and a wallet-bitstream that performs the function of the cryptocurrency wallet. The agent-bitstream 270 may be stored in the second memory 220.

The key 240 stored in the first memory 210 may be a private key (hereinafter, an FPGA-private key) uniquely assigned to each online wallet device. For example, referring to FIG. 1, the first FPGA-private key may be assigned to a first online wallet device 120, and second and third FPGA-private keys may be assigned to 2a and 2b online wallet devices 122 and 124, respectively. In another embodiment, the key 240 stored in the first memory 210 may be a master key. The master key may be the key to be used for a Hierarchical Deterministic Wallet (HD wallet) that generates a new address for each user's wallet whenever the cryptocurrency transaction occurs.

The agent-bitstream 270 stored in the second memory 220 may be a file including programming information for the FPGA. The FPGA chip 230 may be programmed by loading the agent-bitstream 270. For example, a function block for operating in the FPGA chip 230 may be written using a hardware description language such as VHDL or Verilog, and then converted into the bitstream.

The agent-bitstream 270 may include a primitive-agent 250 that accesses the first memory or performs various operations (e.g., encrypting, decrypting, signing, etc.) using the key stored in the first memory, and a wallet-agent 260 that performs various operations to be required for cryptocurrency transactions. In the present embodiment, two agents 250 and 260 are shown separately for convenience of description, but the types and numbers of the agents 250 and 260 may be variously modified depending on embodiments.

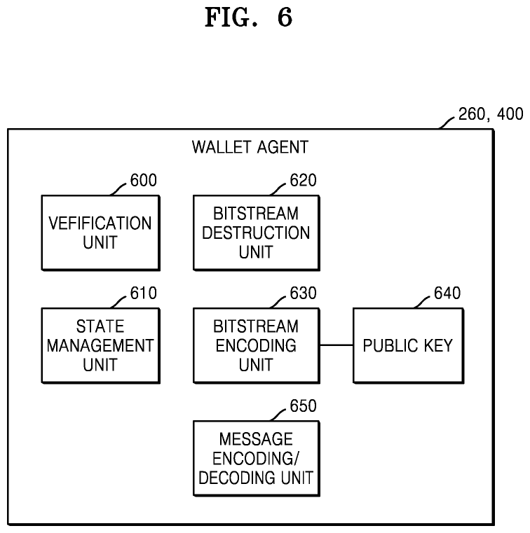

The wallet-agent 260 may have different configurations, such as the number and type of modules to be included therein, depending on the usage environment, such as the type of cryptocurrency processed by the online wallet device 200. For example, in FIG. 1, the wallet-agent of the first online wallet device 120 and the wallet-agent of the second online wallet device 122 may have different configurations. An example of the configuration of the wallet-agent 260 is shown in FIG. 6.

The online wallet devices 120, 122, and 124 installed in the servers 110 and 112 as shown in FIG. 1, may load the agent-bitstream 270 stored in the second memory 220 on the FPGA chip 230 when the servers boot. Since accessing to the first memory 210 or various operations using the keys stored in the first memory 210 are performed only through the FPGA chip 230 that is programmed through loading of the agent-bitstream 270, the key stored in the first memory 210 is not exposed to an outside of the online wallet device 200 and thus may be safely managed.

The online wallet device 200 may include an interface unit (not shown) that is mounted in a card slot of the server and capable of communicating with a CPU of the server. For example, the online wallet device 200 may include the interface unit supporting the PCIe.

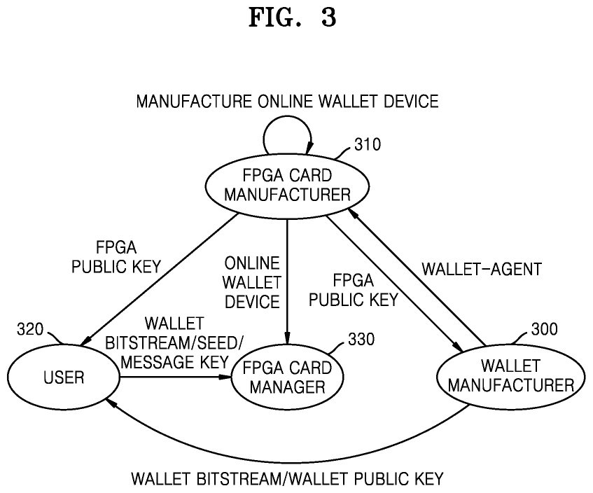

FIG. 3 is a diagram illustrating a relationship between subjects involved in an online wallet according to an embodiment of the present disclosure.

Referring to FIGS. 2 and 3 together, a wallet manufacturer 300 may generate the wallet-agent 260 including a module that performs various operations or actions according to the type of cryptocurrency, etc. and transmit the wallet-agent 260 to an FPGA card manufacturer 310 in the form of Intellectual Property (IP). Here, the IP may mean a function block written in hardware technology language such as VHDL or Verilog for FPGA program.

The FPGA card manufacturer 310 may generate the primitive-agent 250 including a module that performs memory access or key-related operations in the online wallet device 200. That is, the primitive-agent 250 may include a module that performs functions to be commonly required for various types of cryptocurrencies. Therefore, when it is necessary to generate an online wallet device for a new cryptocurrency, only the module of the wallet-agent 260 may need to be changed while maintaining the primitive-agent 250 as it is.

The FPGA card manufacturer 310 may integrate the primitive-agent 250 and the wallet-agent 260 received from the wallet manufacturer 300, convert the integrated the primitive-agent 250 and the wallet-agent 260 into the bitstream that is loadable on the FPGA chip 230, and store the bitstream in the second memory 220 of the online wallet device 200. In addition, the FPGA card manufacturer 310 may generate the FPGA-private key and an FPGA-public key uniquely assigned to the online wallet device 200, then store the FPGA-private key in the first memory 210, and provide the FPGA-public key to the wallet manufacturer 300. The FPGA card manufacturer 310 may store the FPGA-private key in the first memory 210 and then destroy the FPGA-private key. Therefore, the FPGA-private key may exist only in the first memory 210 of the online wallet device 200. The FPGA card manufacturer 310 may manufacture the online wallet device 200 by packaging the first memory 210, the second memory 220, and the FPGA chip 230, and supply the online wallet device 200 to the FPGA card manager 330. Various conventional hardware implementations and process technologies may be applied so that the first and second memories 210 and 220 of the online wallet device 200 may have defense power against physical attacks. The FPGA card manager 330 may mount the online wallet device 200 to be supplied on the transaction server.

The user 320 who wants to transact the cryptocurrency may request the cryptocurrency wallet for cryptocurrency transaction to the wallet manufacturer 300 by designating the type of cryptocurrency to be transacted. For example, when an application for this embodiment is installed on a terminal of the user 320 and the user drives the application, the user terminal may receive information about a transaction server of cryptocurrency and at least one online wallet device mounted on each server from the wallet manufacturer 300, and then provide an interface screen through which the user 320 may select the type of cryptocurrency, the server to be a target of transaction, and the online wallet device in the transaction server. The user may request the cryptocurrency wallet from the wallet manufacturer 300 by designating the type of cryptocurrency, the server to be the target of transaction, and the online wallet device through the interface screen.

The wallet manufacturer 300 may provide the cryptocurrency wallet to the user in the form of the wallet-bitstream in response to the user's request for the cryptocurrency wallet. At this time, the wallet manufacturer 300 may encrypt the wallet-bitstream with the FPGA-public key of the designated online wallet device and provide the encrypted wallet-bitstream to the user 320. In addition, the wallet manufacturer 300 may provide the user 320 with a verification-public key for wallet verification. Thereafter, the user 320 may transact cryptocurrencies by loading the wallet-bitstream on the designated online wallet device. In addition, the user 320 may receive the FPGA-public key for the online wallet device on which the wallet-bitstream is loaded, from the FPGA card manufacturer 310.

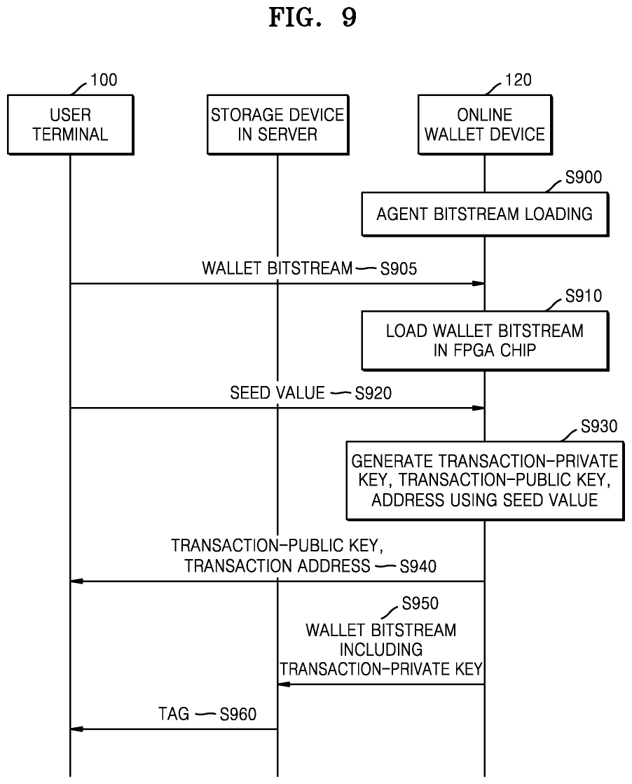

When the user 320 uses the wallet-bitstream for the first time, the user 320 may provide the FPGA card manager 330 with a seed and a message key together with the wallet-bitstream. At this time, the user 320 may encrypt the seed and the message key with the FPGA-public key and transmit the encrypted seed and message key. The wallet-agent of the online wallet device may generate a transaction-private key, a public key, a transaction address, etc. for the transaction of cryptocurrency through the seed, and store the message key in a key storage unit. This will be described again in FIG. 9.

When the user 320 wants to generate the new cryptocurrency wallet for reasons such as loss of the wallet-bitstream or a new type of cryptocurrency transaction, the user 320 may request the wallet manufacturer 300 to generate a new wallet. The wallet manufacturer 300 may generate and provide a new wallet-bitstream that meets the user's request. For example, when the user 320 who used the wallet-bitstream for the transaction of a cryptocurrency A wants to transact a cryptocurrency B, the wallet manufacturer 300 may provide the user 320 with the new wallet-bitstream in which a module for transaction of the cryptocurrency B is added in the existing wallet-bitstream.

In the present embodiment, for convenience of explanation, each subject is represented by the manufacturer 300 and 310, the user 320, the manager 330, etc. but each subject 300, 310, 320, and 330 may include the server or the terminal. For example, the wallet manufacturer 300 may be the server or the terminal, and may transmit the wallet agent to the server or the terminal of the FPGA card manufacturer 310 through online. In addition, the user 320 may be the user terminal, and when the user terminal requests the cryptocurrency wallet, that is, the online wallet, to the server or the terminal of the wallet manufacturer 300, the server or terminal of the wallet manufacturer 300 may transmit the wallet-bitstream to the user terminal.

As another example, the FPGA card manager 330 may be the same subject as the user 320 or may be the same subject as the wallet manufacturer 300. When the FPGA card manager 330 is the user 320, the user may connect the online wallet device provided by the FPGA card manufacturer 310 to its own terminal and use the online wallet device. When the FPGA card manager 330 is the wallet manufacturer 300, the wallet manufacturer 300 may manage the online wallet device instead of the user and process the transaction of cryptocurrency, etc.

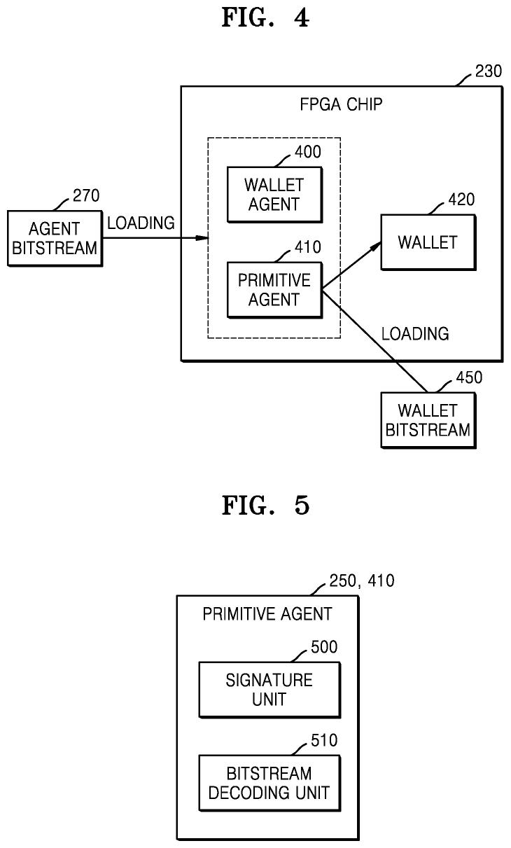

FIG. 4 is a diagram illustrating an example of loading a bitstream on an online wallet device according to an embodiment of the present disclosure.

Referring to FIGS. 2 and 4 together, when the online wallet device 200 is booted, the agent-bitstream 270 stored in the second memory 220 of the online wallet device 200 may be loaded on the FPGA chip 230 and then a wallet-agent 400 and a primitive-agent 410 may be installed on the FPGA chip 230. In addition, the online wallet device 200 may receive a wallet-bitstream 450 from the outside and load the wallet-bitstream 450 on the FPGA chip 230. Since the wallet-bitstream 450 loaded on the FPGA chip 230 performs the function of cryptocurrency wallet, the wallet-bitstream 450 loaded on the FPGA chip 230 is hereinafter referred to as a wallet 420.

The wallet-bitstream 450 may include the private key (hereinafter, a transaction-private key) for cryptocurrency transactions. In addition to this, the wallet-bitstream 450 may further include a transaction module that performs the accessing to the transaction-private key or performs a transaction-private key-related operation, and transaction-related state information. An example of a detailed configuration of the wallet-bitstream 450 is shown in FIG. 7. As another example, when the wallet manufacturer 300 shown in FIG. 3 issues the wallet-bitstream to the user, the transaction-private key may not exist in the wallet-bitstream. In this case, the online wallet devide 200 may perform a process of generating a transaction key when the wallet-bitstream of the user for which the transaction-private key does not exist is loaded. To this end, the agent-bitstream 270 or the wallet-bitstream 450 may include an agent for generating the transaction key. An example of the process of generating of the transaction-private key will be described again in FIG. 9.

The wallet-bitstream 450 may be encrypted with the FPGA-public key assigned to the online wallet device 200. In this case, the primitive-agent 410 may decrypt the wallet-bitstream 450 by using the FPGA-private key stored in the first memory 210 of the online wallet device 200. Since the FPGA-private key and the corresponding FPGA-public key exist for each online wallet device, the wallet-bitstream 450 may be decrypted only in the designated online wallet device 200 and then loaded on the FPGA chip 230. When the wallet-bitstream 450 is transmitted to another online wallet device, the wallet-bitstream 450 may not be normally decrypted and thus, it is possible to prevent the wallet-bitstream 450 from being used in another online wallet device that is not designated regardless of whether it is malicious or mistaken.

FIG. 5 is a diagram illustrating an example of a configuration of a primitive-agent according to an embodiment of the present disclosure.

Referring to FIGS. 4 and 5 together, the primitive-agent 410 to be installed in the FPGA chip 230 through the loading of the agent-bitstream 270 may include modules such as a signature unit 500 and a bitstream decrypting unit 510.

The bitstream decrypting unit 510 may decrypt the wallet-bitstream 450 received from the outside, by using the FPGA-private key stored in the first memory 210. When the decrypting is succeeded, the wallet 420 may be normally installed on the FPGA chip 230. On the other hand, when the decrypting fails, the wallet 420 may not be normally installed.

The signature unit 500 may include the function of signing with the FPGA-private key stored in the first memory 210 for the verification of the online wallet, which is explained later. A method of verifying the online wallet will be described in FIG. 11.

FIG. 6 is a diagram illustrating an example of a configuration of a wallet-agent according to an embodiment of the present disclosure.

Referring to FIGS. 4 and 6 together, the wallet-agent 400 installed in the FPGA chip 230 through the loading of the agent-bitstream 270 may include modules such as a verification unit 600, a state management unit 610, a bitstream destruction unit 620, a bitstream encrypting unit 630, an FPGA-public key 640, and a message encrypting/decrypting unit 650.

The verification unit 600 may provide a function for the user to remotely verify whether the wallet 420 is normally installed in the online wallet device 200. For example, the verification unit 600 may receive a first signature written with the FPGA-private key stored in the first memory 210 from the signature unit 500 shown in FIG. 5, generate a second signature written with a verification-private key that is included in the wallet 420 loaded on the online wallet device 200, and transmit the first signature and the second signature to the user terminal. The user terminal may verify whether the wallet or the like is correctly installed by verifying the first signature and the second signature with the FPGA-public key and the verification-public key. A more detailed verification method is shown in FIG. 11.

When the cryptocurrency is transacted, the state management unit 610 may update transaction-related state information including transaction details. For example, the state management unit 610 may update the transaction related state information that is included in the wallet 420 loaded on the FPGA chip 230 by reflecting the new transaction details.

The bitstream encrypting unit 630 may encrypt the wallet-bitstream 450 in which transaction-related status information has been updated with the FPGA-public key 640.

When the transaction of cryptocurrency is completed, the bitstream destruction unit 620 may delete the wallet 420 loaded on the online wallet device 230. For example, upon receiving a transaction completion message from the user terminal, the bitstream destruction unit 620 may destroy the wallet 420 loaded on the FPGA chip 230. Then, the online wallet device 230 may wait for the next user to load the wallet-bitstream.

The message encrypting/decrypting unit 650 may encrypt/decrypt a message transmitted/received with an external device such as the user terminal. For example, the online wallet device 230 may transmit and receive data for cryptocurrency transaction, online wallet verification, initial transaction-private key generation, etc. using a message encrypted with the message key. The message key used for encrypting/decrypting of the message may be included in the wallet 420.

FIG. 7 is a diagram illustrating an example of a configuration of a wallet-bitstream according to an embodiment of the present disclosure.

Referring to FIGS. 4 and 7 together, the wallet 420 installed in the FPGA chip 230 through the loading of the wallet-bitstream 270 may include modules such as a transaction module 700, a state storage unit 710, a key storage unit 720, and a key generation unit 730.

The transaction module 700 may perform the access to various keys stored in the key storage unit 710 or may perform various operations using keys. The state storage unit 710 may accumulate and store transaction-related state information of cryptocurrency.

The key storage unit 720 may include the transaction-private key, the verification-private key, and the message key. For example, when the generation of the user address is required for the cryptocurrency transaction, the transaction module 700 may generate the transaction-public key using the transaction-private key, and generate the transaction address using the transaction-public key. The transaction details may be stored based on the transaction address. The verification-private key may be a key to be used by the verification unit 600 of FIG. 6 for remote verification of the online wallet, and the message key may be a key to be used by the message encrypting/decrypting unit 650 of FIG. 6. The key generation unit 730 may generate the transaction-private key based on a seed value.

Each configuration described with reference to FIGS. 4 to 7 is only an example of the online wallet device 230 and is not necessary limited to the configuration. Depending on embodiments, an agent constituting the agent-bitstream 270 and a module included in each agent may be variously modified according to the embodiment.

FIG. 8 is a flowchart illustrating an example of a method of generating an online wallet according to an embodiment of the present disclosure.

Referring to FIGS. 2 and 8 together, the FPGA card manufacturer may store the key 240 in the first memory 210 (S800), and store the agent-bitstream 270 in the second memory 220 (S810). The key 240 to be stored in the first memory 210 may include the FPGA-private key assigned to each online wallet device. The agent-bitstream 270 may include the agent that performs the accessing to the key stored in the first memory 210 or performs the key-related operation. An example of the agent-bitstream 270 is shown in FIG. 4. The FPGA card manufacturer 310 may generate the online wallet device 230 by packaging the FPGA chip 230 together with the first and second memories 210 and 220.

FIG. 9 is a flowchart illustrating another example of a method of generating an online wallet according to an embodiment of the present disclosure. For convenience of explanation, the description will be made based on the specific user terminal 100 and the online wallet device 120 of the first server 110 shown in FIG. 1. Other embodiments below are also the same.

Referring to FIGS. 2 and 9, the online wallet device 120 may load the agent-bitstream 270 stored in the second memory 220 on the FPGA chip 230 (S900). The online wallet device 120 may load the wallet-bitstream 450 in FIG. 4 received from the user terminal 100 on the FPGA chip 230 (S905 and S910).

When the wallet-bitstream is encrypted with the FPGA-public key, the primitive-agent 410 in FIG. 4 of the agent-bitstream 270 that is loaded on the FPGA chip 230 may decrypt the wallet-bitstream 450 with the FPGA-private key stored in the first memory 210, and the decrypted wallet-bitstream 450 may be loaded on the FPGA chip 230 to install the wallet 420.

When the wallet-bitstream 450 is first loaded on the online wallet device 120, the online wallet device 120 may receive the seed value encrypted with the FPGA-public key from the user terminal 100 (S920). As an embodiment, the user terminal 100 may transmit the message key as well as the seed value to the online wallet device 120. Here, the seed value or the message key may be encrypted with the FPGA-public key and transmitted. In this case, the online wallet device 120 (for example, the bitstream decrypting unit 520 of FIG. 5) may decrypt the seed value or the message key using the FPGA-private key stored in the first memory.

The online wallet device 120 may generate the transaction-private key, the transaction-public key, and the transaction address, etc. for cryptocurrency transactions by using the seed value (S930). Depending on embodiments, the online wallet device 120 may generate the transaction-private keys for several cryptocurrencies from one seed value. When the online wallet device 120 receives the message key, the online wallet device 120 may store the message key in the wallet (for example, the key storage unit 720 of FIG. 7).

The online wallet device 120 may encrypt the transaction-public key and the transaction address, etc. with the message key or the FPGA-public key and provides the same to the user terminal 100 (S940), and also may encrypt the wallet-bitstream including the transaction-private key (or the message key) with the FPGA-public key and store the same in the storage device in the server (S950). Each step (S905 to S950) of receiving the wallet-bitstream and generating the transaction-private key, etc. may be performed by the agent included in the agent-bitstream 270. After the process of generating the transaction-private key, the message key, etc. in the wallet-bitstream, the server may transmit a separate tag indicating a version of the wallet-bitstream to the user terminal (S960).

In another embodiment, when the wallet-bitstream is lost or the online wallet device fails, the private key for cryptocurrency transaction may be recovered. For example, the user terminal 100 may re-issue the wallet-bitstream from the wallet manufacturer 300 in FIG. 3, and then recover the private key by performing again the process (S920 to S950) of generating the private key by using the previously explained seed value.

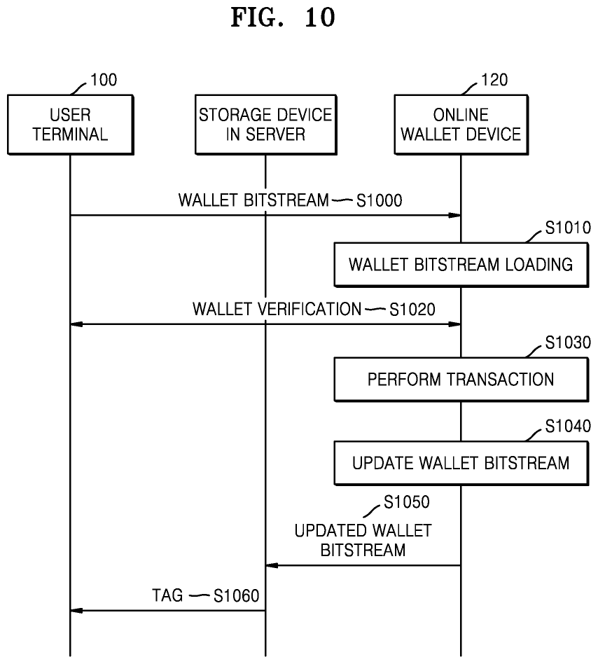

FIG. 10 is a flowchart illustrating an example of a method of updating an online wallet according to an embodiment of the present disclosure.

Referring to FIGS. 2 and 10 together, the online wallet device 120 may load the wallet-bitstream 450 in FIG. 4 received from the user terminal on the FPGA chip 230 and install the wallet 420 (S1000 and S1010). Depending on embodiments, the user terminal 100 may remotely verify whether the wallet 420 is normally installed in the online wallet device 120 (S1020). A method of verifying the wallet will be described again in FIG. 11.

The online wallet device 120 may perform various operations for performing the transaction such as cryptocurrency (S1030). For example, the online wallet device 120 may perform the operation for cryptocurrency transaction using the transaction-private key included in the wallet 420.

When the transaction of cryptocurrency, etc. is completed, the online wallet device 120 may encrypt the wallet-bitstream in which the transaction-related status information has been updated, with the FPGA-public key (S1040), and store the encrypted wallet-bitstream in the storage device in the server (S1050). In this case, the server may transmit the separate tag indicating the version to the user terminal 100 so that the user terminal 100 may check whether the wallet-bitstream has been updated (S1060). The online wallet device 120 may encrypt the separate tag with the message key and transmit the same.

FIG. 11 is a flowchart illustrating an example of a method of verifying an online wallet according to an embodiment of the present disclosure.

Referring to FIGS. 2 and 11 together, when the online wallet device 120 receives a nonce value from the user terminal 100 (S1100), the online wallet device 120 may generate a first signature written with the FPGA-private key stored in the first memory 210 (S1120). In addition, the online wallet device 120 may generate a second signature written with the verification-private key included in the wallet 420 (S1130). For example, referring to FIGS. 5 to 7, the verification unit 600 of the wallet-agent 260 may request the first signature from the signature unit 500 of the primitive-agent 250, and the signature unit 500 may generate the first signature signed by the nonce value using the FPGA-private key stored in the first memory 210 and transmit the first signature to the verification unit 600. In addition, the verification unit 600 may generate the second signature signed with the verification-private key stored in the key storage unit 720 of FIG. 7 of the wallet 420.

The online wallet device 120 may provide the first signature and the second signature to the user terminal 100 (S1130). The user terminal 100 may verify the first signature and the second signature using the FPGA-public key and the verification-public key to confirm whether the wallet is installed correctly (S1140). In this embodiment, it is assumed that the FPGA-public key and the verification-public key may be previously provided to the user terminal through various conventional methods.

When the server is occupied due to a hacker's attack or the wallet-bitstream is stolen to the outside, and thus the operation is attempted on an unauthorized online wallet device, the wallet-bitstream may not operate normally. The wallet-bitstream may operate normally only within the online wallet device certified by the user, and the user may remotely verify the integrity of the transaction.

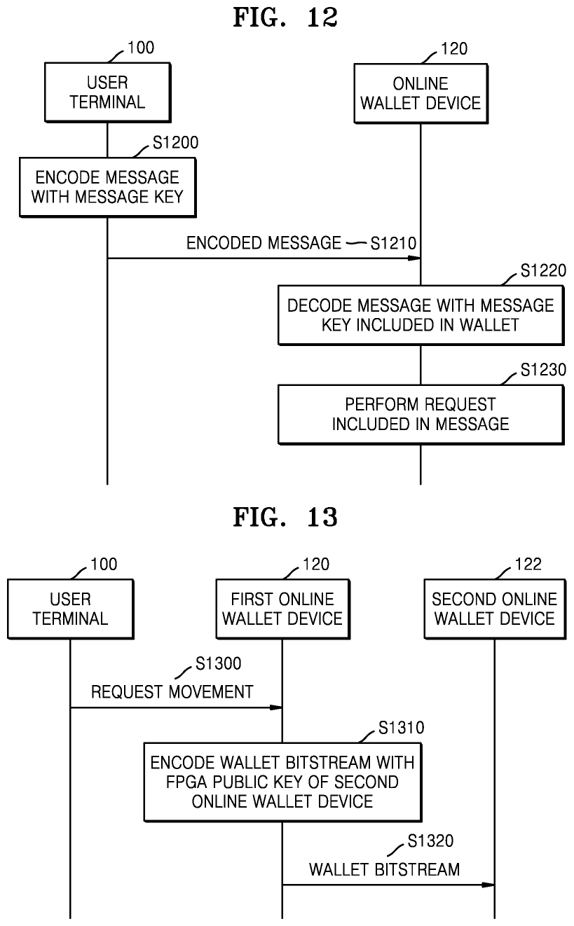

FIG. 12 is a flowchart illustrating an example of a method of transacting cryptocurrency according to an embodiment of the present disclosure.

Referring to FIGS. 2 and 12 together, the user terminal 100 may encrypt and transmit the message of transaction request with the message key (S1200 and S1210). When the online wallet device 120 receives the encrypted message, the online wallet device 120 may decrypt the encrypted message using the message key included in the wallet 420 (S1220). For example, referring to FIGS. 6 and 7, the message encrypting/decrypting unit 650 may decrypt the message using the message key stored in the key storage unit 720 of the wallet 420.

The online wallet device 120 may perform the request included in the message (S1230). For example, referring to FIGS. 6 and 7, the wallet 420 may perform the cryptocurrency transaction and sign a transaction execution content with the transaction-private key. Then, the server 110 may broadcast the corresponding transaction signature through peer-to-peer (P2P). During the transaction, when the user requests to view it's own transaction details, the online wallet device 120 may encrypt the accumulated transaction details with the message key and transmit the encrypted transaction details to the user terminal 100. The user terminal 100 may decrypt and display the accumulated transaction details with the message key.

FIG. 13 is a flowchart illustrating an example of a method of moving an online wallet according to an embodiment of the present disclosure.

Referring to FIG. 13, a first online wallet device 120 may receive a movement request from the user terminal 100 (S1300). The movement request may include a request to move to another online wallet device in the same server or a request to move to an online wallet device from another server. For example, referring to FIG. 1, the user may request to move from the first server 110 that is currently used to the second online wallet device 122 of the second server 112. The present embodiment will be described on the assumption that there is the request for movement from the first server 110 to the second online wallet device 122 of the second server 112.

The first online wallet device 120 of the first server 110 may encrypt the wallet-bitstream loaded on the first online wallet device 120 with the FPGA-public key assigned to the second online wallet device 122 (S1310), and may transmit the encrypted wallet-bitstream to the second online wallet device 122 (S1320). The second online wallet device 122 may decrypt the received wallet-bitstream by using the FPGA-private key stored in its own first memory and loads the decrypted wallet-bitstream on the FPGA chip. Thereafter, the user may perform the cryptocurrency transaction using the second online wallet device 122.

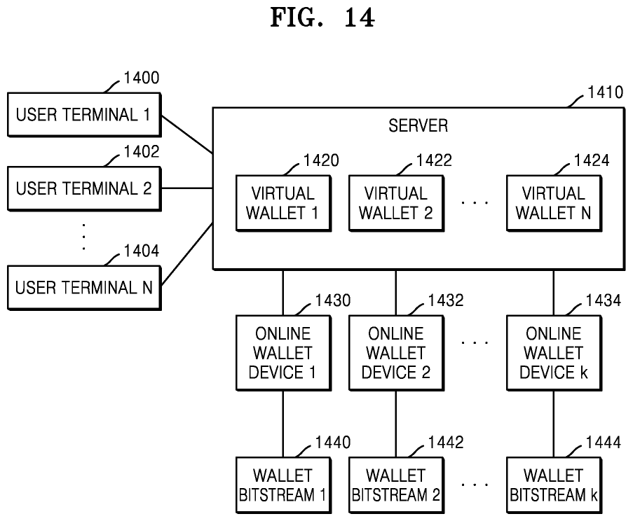

In embodiments described in FIGS. 1 to 13, each user's wallet-bitstream may be loaded on the corresponding online wallet device and then cryptocurrency transactions may be performed. In other words, when there are 100 cryptocurrency transaction requests, the server may need to load 100 wallet-bitstreams. The larger the number of users who perform cryptocurrency transactions through the server, the longer it may take for the server to perform and process operations for cryptocurrency transactions. Accordingly, an embodiment capable of increasing the efficiency of the cryptocurrency transaction of the server will be described in FIG. 14.

FIG. 14 is a diagram illustrating an example of a method of increasing the efficiency of cryptocurrency transactions according to an embodiment of the present disclosure.

Referring to FIG. 14, a server 1410 equipped with at least one online wallet device 1430, 1432, and 1434 may include virtual wallets 1420, 1422, and 1424 for each user. Here, the virtual wallets 1420, 1422, and 1424 may be for virtual cryptocurrency transactions between the user terminals 1400, 1402, and 1404 and the server 1410, and transaction-private keys or transaction addresses included in the virtual wallets 1420,1422, and 1424 may not be used for actual cryptocurrency transactions. The transaction addresses of the virtual wallets 1420, 1422, and 1424 may be used as a kind of virtual account.

For example, when N users are subscribed to the server 1410, there may be N virtual wallets 1420, 1422, and 1424 in the server 1410 for each user. Each user may request the cryptocurrency transaction from the server using the virtual wallets 1420, 1422, and 1424. The virtual wallets 1420, 1422, and 1424 may be various types of conventional wallets for cryptocurrency transactions including the online wallet of the present embodiment, and are not limited to a specific type. The virtual wallets 1420, 1422, and 1424 may be generated by the server 1410 whenever the user subscribes.

The server 1410 may transact cryptocurrency by loading the wallet-bitstreams 1440, 1442, and 1444 on the online wallet devices 1430, 1432, and 1434, as in the embodiments described in FIGS. 1 to 13. However, the wallet-bitstreams 1440, 1442, and 1444 to be loaded on each of the online wallet devices 1430, 1432, and 1434 may not be assigned to each user, but assigned by the server 1410. For example, when K online wallet devices 1430, 1432, and 1434 are installed in the server 1410, at least one wallet-bitstream 1440, 1442, and 1444 for each online wallet device 1430, 1432, and 1434 may exist. The wallet-bitstreams 1440, 1442, and 1444 of the present embodiment may be stored and managed in a separate storage medium by the FPGA card manager 330 in FIG. 3.

When transaction requests for cryptocurrency using virtual wallets 1420, 1422, and 1424 are received from the user terminals 1400, 1402, and 1404, the server 1410 may collect the transaction requests for these cryptocurrencies, and then perform the actual cryptocurrency transaction by using wallet-bitstreams 1440, 1442, and 1444 to be loaded on the online wallet devices 1430, 1432, and 1434. For example, when cryptocurrency transaction requests are received from N user terminals 1400, 1402, and 1404, the server 1410 may divide N cryptocurrency transaction requests into K groups that are the number of the equipped online wallet device 1430, 1432, and 1434 and collect the cryptocurrency transactions of each group, and then transact the cryptocurrency by using the wallet-bitstreams 1440, 1442, and 1444 of each online wallet devices 1430, 1432, and 1434 for each group. As another example, the server 1410 may collect cryptocurrency transactions in a predetermined time unit and transact the cryptocurrency through each online wallet device 1430, 1432, and 1434.

For example, when 5 online wallet devices 1430, 1432, and 1434 are installed in the server 1410, and when cryptocurrency transaction requests are received from 100 user terminals 1400, 1402, and 1404, the server 1410 may collect every 20 cryptocurrency transaction requests, and then process the cryptocurrency transaction requests at once through 5 online wallet devices 1430, 1432, and 1434. Then, when the cryptocurrency transaction is completed, the server 1410 may reflect the cryptocurrency transaction in the transaction contents of each user using the virtual wallets 1420, 1422, and 1424. That is, when receiving a transaction request for 1 bitcoin from the first user terminal 1400 and the second user terminal 1402, the server 1410 does not process each, but may process the transaction of 2 bitcoins at once through the first online wallet device 1430, and reflect the transaction details to each user using the virtual wallets 1420 and 1422 of the first and second users.

The present disclosure may also be implemented as computer-readable code on a computer-readable recording medium. The computer-readable recording medium may include all types of recording devices that store data that may be read by a computer system. Examples of the computer-readable recording media may include ROM, RAM, CD-ROM, magnetic tape, floppy disk, and optical data storage device, etc. In addition, the computer-readable recording medium may be distributed on the computer system that is connected through a network, and then computer-readable codes may be stored and executed in a distributed manner.

So far, the present disclosure has been looked at around its preferred embodiments. Those of ordinary skill in the technical field to which the present disclosure belongs will be able to understand that the present disclosure may be implemented in a modified form within the scope that does not deviate from the essential characteristics of the present disclosure. Therefore, the disclosed embodiments should be considered from an illustrative point of view rather than a limiting point of view. The scope of the present disclosure may be indicated in the claims rather than the above description, and all differences within the scope of the present disclosure should be interpreted as being included in the present disclosure.

1. An online wallet device comprising:
a first memory in which a key is stored;
a second memory for storing an agent-bitstream comprising at least one agent that accesses the key stored in the first memory or performs a key-related operation; and
a field programmable gate array (FPGA) chip on which at least one agent is installed through loading of the agent-bitstream.

2. The online wallet device of claim 1, further comprising an interface unit for transmitting and receiving data to and from an external central processing unit (CPU).

3. The online wallet device of claim 1, wherein
the first memory and the second memory are each implemented as read-only memory (ROM), and
the first memory is logically or physically separated from the second memory.

4. The online wallet device of claim 1, wherein the agent-bitstream comprises an agent for loading a wallet-bitstream on the FPGA chip, and the wallet-bitstream comprises a transaction-private key for a cryptocurrency.

5. The online wallet device of claim 1, wherein the wallet-bitstream is received from a storage device in a server or another online wallet device.

6. The online wallet device of claim 4, wherein
the key is an FPGA-private key assigned to each online wallet device,
the wallet-bitstream is encrypted with an FPGA-public key assigned to each online wallet device, and
the agent decrypts the wallet-bitstream with the FPGA-private key and loads the decrypted wallet-bitstream on the FPGA chip.

7. The online wallet device of claim 4, wherein
the wallet-bitstream comprises a transaction-private key for a cryptocurrency, the transaction-private key being generated based on a seed value;
a transaction module that accesses the transaction-private key or performs a key-related operation; and
status information comprising transaction details about the cryptocurrency.

8. The online wallet device of claim 4, wherein
the wallet-bitstream comprises a message key, and
the agent-bitstream comprises an agent that decrypts a message received with a message key in the wallet-bitstream.

9. The online wallet device of claim 1, wherein
the agent-bitstream comprises a public key assigned to the FPGA chip; and
an agent that encrypts a wallet-bitstream with the public key, in which transaction-related status information of a cryptocurrency is updated.

10. The online wallet device of claim 1, wherein the agent-bitstream comprises an agent that destroys a wallet-bitstream loaded on the FPGA chip when transaction of cryptocurrency is completed.

11. The online wallet device of claim 1, wherein the agent-bitstream comprises an agent that encrypts a wallet-bitstream with an FPGA-public key assigned to a third online wallet device.

12. The online wallet device of claim 1, wherein the agent-bitstream comprises an agent that generates a first signature using the key stored in the first memory and a second signature using a verification-private key that is comprised in a wallet-bitstream that is loaded on the FPGA chip.

13. A method of generating an online wallet, the method comprising:
storing a key in a first memory;
storing an agent-bitstream in a second memory, the agent-bitstream comprising at least one agent that accesses the key stored in the first memory or performs a key-related operation; and
packaging a field programmable gate array (FPGA) chip connected to the first memory and the second memory.

14. The method of claim 13, wherein
the first memory and the second memory are each implemented as read-only memory (ROM), and
the first memory is logically or physically separated from the second memory.

15. The method of claim 13, wherein the key is an FPGA-private key assigned to each online wallet device.

16. The method of claim 15, wherein
the agent-bitstream comprises a primitive-agent that decrypts a wallet-bitstream comprising a transaction-private key for a cryptocurrency with the FPGA-private key and loads the decrypted wallet-bitstream on the FPGA chip; and
a wallet-agent that updates transaction-related status information of the wallet-bitstream and encrypts the updated transaction-related status information with an FPGA-public key corresponding to the FPGA-private key.

17. The method of claim 16, wherein the FPGA-public key is included in the agent-bitstream.

18. A method of generating an online wallet, the method comprising:
loading an agent-bitstream on a field programmable gate array (FPGA) chip, in which the agent-bitstream comprises at least one agent that accesses a key stored in a memory or performs a key-related operation; and
installing a wallet of an user by decrypting a wallet-agent comprising a transaction key for a cryptocurrency with the key and loading the decrypted wallet-agent on the FPGA chip.

19. The method of claim 18, wherein the key is an FPGA-private key assigned to each online wallet device.

20. The method of claim 18, further comprising updating transaction-related status information of the wallet-bitstream and encrypting the updated wallet-bitstream with an FPGA-public key assigned to each online wallet device.

21. The method of claim 18, further comprising
generating a transaction-private key for a cryptocurrency based on a seed value received from a user terminal; and
encrypting a wallet-bitstream comprising the transaction-private key with an FPGA-public key assigned to each online wallet device and providing the encrypted wallet-bitstream to a storage device in a server.

22. A method of verifying an online wallet, the method comprising:
loading a wallet-bitstream received from a user terminal on a field programmable gate array (FPGA) chip of an online wallet device;
generating a first signature by signing a nonce value received from the user terminal with a key stored in a memory of the online wallet device;
generating a second signature by signing the nonce value with a verification-private key that is included in the wallet-bitstream; and
transmitting the first signature and the second signature to the user terminal.

23. The method of claim 22, wherein the key is an FPGA-private key assigned to each online wallet device.

24. The method of claim 23, wherein the loading comprises decrypting an encrypted wallet bitstream with the FPGA-private key.

25. A computer-readable recording medium comprising a computer program for performing the methods according to claim 13.
